(19) United States
(12) Patent Application Publication
(10) Pub. No.: US 2008/0045138 A1
(43) Pub. Date: Feb. 21, 2008

(54) Context information communications via a mobile device

(75) Inventors: Natasa Milic-Frayling, Cambridge (GB); Jamie Costello, St. Albans (GB); Anthony Francis Frayling, Cambridge (GB)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/414,967

(22) Filed: May 1, 2006

(51) Int. Cl. H04H 1/00

(52) U.S. Cl. 455/3.04

(57) ABSTRACT

Context information communications allow a user to capture one or more locations and associated context information during a “journey”. Locations may be captured as GPS data or other position data. Context information may include images, video, audio, text, and other context information. The resulting context and locations can be saved to an aggregation server for remote access by another user via a web browser or via another mobile phone. Likewise, two users can do this concurrently, sharing their locations and images during their travels, thereby allowing each user to track the travels of the other user along with images taken by the other user.

### BACKGROUND

Existing mobile communications are typically performed via voice or data messaging, such as mobile phone communications, text messaging, emailing, and media messaging (e.g., videoconferencing). These communication types provide acceptable means for direct, active communications between two parties. For example, to accomplish such communications, the sending party generates a message (e.g., speaking into the phone, typing an email, etc.) and transmits the message to a receiving party. The receiving party then focuses his or her attention on the received message (e.g., listening to the sender's voice, reading the email message, etc.), and potentially responds. Such communications are typically synchronous in nature and demand the attention of both senders and receivers.

Mobile communication devices are also being integrated with other devices and subsystems. For example, mobile communications devices may be equipped or associated with positioning devices, such as global positioning system (GPS) transceivers, that can detect the location of the device within a certain region or even globally. Mobile communications devices may also be equipped or associated with media and messaging devices, subsystems, and software, including still cameras, video cameras, audio recorders, and text messaging systems.

However, existing approaches tend to treat these features independently and fail to take advantage of them in combination. For example, if two individuals are geographically separated and wish to share the separate travel experiences, there are no adequate means of communications for facilitating a rich sustained interaction that allows users to communicate their travel experiences to others.

### SUMMARY

Implementations described and claimed herein address the foregoing problems by providing context information communications that allow a user to capture one or more locations and associated context information during a “journey”. Locations may be captured as GPS data or other position data. Context information may include images, video, audio, text, and other context information. The resulting context and locations can be saved to an aggregation server for remote access by another user via a web browser or via another mobile phone. Likewise, two users can do this concurrently, sharing their locations and images during their travels, thereby allowing each user to track the travels of the other user along with images taken by the other user. Alternatively, an aggregation server can be used as an aggregation and transport medium that delivers information to local servers or devices of a single recipient or of multiple recipients, including the sender, for immediate or later viewing, without storing information centrally.

In some implementations, articles of manufacture are provided as computer program products. One implementation of a computer program product provides a tangible computer program storage medium readable by a computer system and encoding a computer program. Another implementation of a computer program product may be provided in a computer data signal embodied in a carrier wave by a computing system and encoding the computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example display of context information on a mobile wireless communications device.

FIG. 2 illustrates an example display of context information on a client device.

FIG. 3 illustrates an example system that processes context information.

FIG. 4 illustrates example operations for processing location information on a mobile wireless communications device.

FIG. 5 illustrates example operations for processing context information on a mobile wireless communications device.

FIG. 6 illustrates example operations for tracking context information on two mobile wireless communications devices.

FIG. 7 illustrates example operations for accessing context information captured by a mobile wireless communications device.

FIG. 8 illustrates an example mobile device that may be useful in implementing the described technology.

FIG. 9 illustrates an example system that may be useful in implementing the described technology.

### DETAILED DESCRIPTIONS

A context information communications method is provided that allows a user to capture one or more locations and associated context information during a “journey”. For example, a user can take digital photographs (e.g., a type of context information) using her mobile phone during a drive along a coast, recording the pertinent locations via a GPS transceiver. The resulting images and locations can be saved to an aggregation server for remote access by another user (e.g., her daughter) via a web browser or via another mobile phone. Likewise, two users can do this concurrently, sharing their locations and images during their travels, thereby allowing each user to track the travels of the other user along with images taken by the other user. Alternatively, an aggregation server can be used as an aggregation and transport medium that delivers information to local servers or devices of a single recipient or of multiple recipients, including the sender, for immediate or later viewing, without storing information centrally.

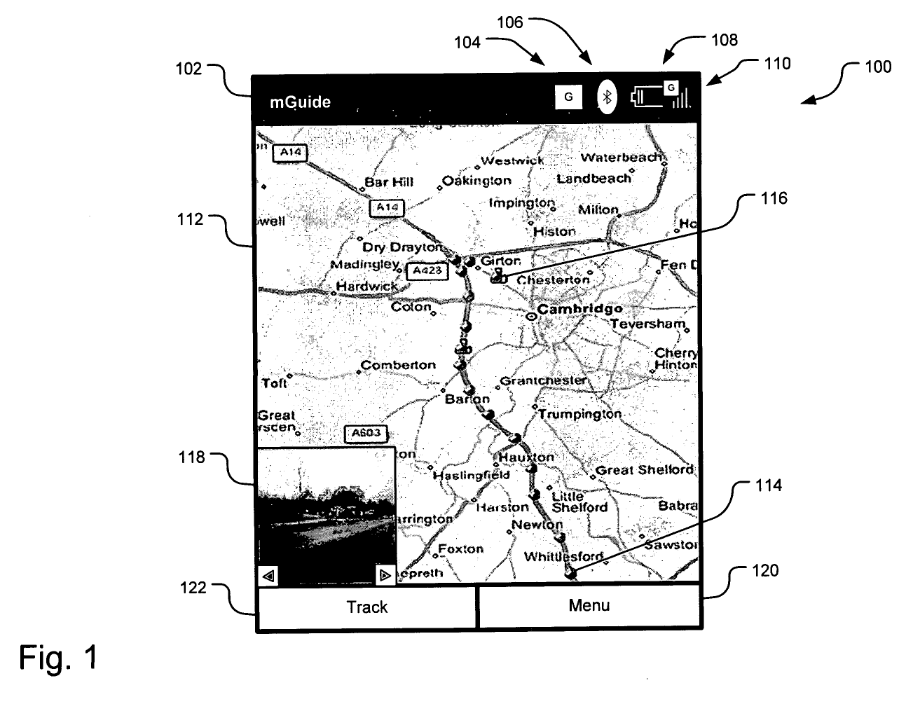

FIG. 1 illustrates an example display 100 of context information on a mobile wireless communications device. A mobile wireless communications device may include a variety of different devices, including a mobile telephone, a personal data assistant (PDA) with wireless networking capabilities, a tablet computer with wireless networking capabilities, and other systems with such communications systems, including vehicles equipped with mobile wireless communications systems. The example aggregation client application executes on the mobile wireless communications device and communicates with a positioning system and a web service at an aggregation web server that obtains and provides mapping data. In one implementation, the aggregation client connects with a GPS device via a Bluetooth connection and connects to the web service via a General Packet Radio Service (GPRS) connection, although other combinations of communication protocols may be employed. Alternatively, the aggregation server may provide a push-based service, such as one based on WapPush, or Multimedia Message Service (MMS).

As described below, the mobile wireless communications device can capture context information (e.g., digital images, digital video, digital audio, text messages, etc.), obtain information indicating its location (e.g., from the GPS device), and record and/or display this information in the display 100. It should also be understood that the contextual information may be prerecorded and merely associated with the location information captured by the mobile device. In the illustrated display 100, the information is displayed on a map, including location indicators from multiple points in time and an image associated with one of those locations. In this manner, the user can capture rich context information along a traveled path and save it for later review. By communicating this information to a web service, the user can also make it available to others to view and share in the experience. In one implementation, the map is retrieved from a web-based mapping service, such as Microsoft Corporation's VIRTUAL EARTH mapping service, through a web service at a web server to which the client is connected, although other sources of mapping data may be employed (e.g., other mapping services, CD or flash memory based maps, etc.).

The display 100 represents a display from a mobile telephone, although other mobile wireless communications devices are also contemplated. The panel 102 displays the name of an example aggregation client application “mGuide”, an icon 104 indicating a General Packet Radio Service (GPRS) connection, an icon 106 indicating a Bluetooth connection (e.g., with a GPS transceiver or other positioning device), an icon 108 indicating the battery charge level of the mobile telephone, and an icon 110 indicating the strength of the wireless communications signal (e.g., a Global System for Mobile Communications (GSM) communications signal in the case of the example mobile telephone of FIG. 1).

Other signaling protocols may be supported in any combination by an example mobile wireless communications device, including without limitations Code Division Multiple Access (CDMA), and Universal Mobile Telecommunications System (UMTS), and any other network telephony protocol. Data can be alternatively or simultaneously communicated using Circuit Switched Data (CSD), GPRS, High Speed Downlink Packet Access (HSDPA), Bluetooth, wireless local area network (WLAN), or any other data transfer protocol.

A map panel 112 displays a map associated with locations captured by a positioning device communicating with the mobile wireless communications device. In one implementation, the mobile wireless communications device communicates with the positioning device via a wireless (e.g., Bluetooth) connection, however, other configurations may include a wired connection, such as being connected through a Secured Digital (SD) slot or other wired connector link.

The map panel 112 includes multiple location indicators (see e.g., location indicator 114) along a route traveled by a user who was carrying the positioning transceiver that was communicating with the mobile wireless communications device. At multiple points along the traveled path, the GPS transceiver captured its location in a location tag and sent this location tag to the mobile wireless communications device. In one implementation, the mobile wireless communications device generates a location indicator specified by the location tag. In another implementation, the mobile wireless communications device sends the location tag to a web service, which generates a new map that includes a location indicator identifying the captured location and potentially other location identifiers on the device's traveled path and sends the new map back to the mobile wireless communications device for display.

The map panel 112 also includes a camera indicator (see e.g., camera indicator 116) that indicates that an image has been associated with the location indicator. The associated image is displayed in an image panel 118, which includes next and previous controls to allow the user to step through the images captured along the traveled path. The user can select (e.g., via a touch screen or keyboard on the device) the associated image to display a larger version of the image in the display 100. If the location indicators are associated with time stamps (as in most implementations), the images can be stepped through in a temporal fashion.

A “menu” control 120 provides access to various features of the aggregation client application, which are described below. Example menu items include without limitation:

| Menu Item | Description |
|---|---|
| Menu→Options→Login | Allows the user to provide login information |
| | for accessing the aggregation server and the |
| | context datastore |
| Menu→GPS→Connect | Establishes a Bluetooth connection between |
| | mobile wireless communications device and |
| | a positioning transceiver |
| Menu→New Journey | Resets location and context information set |
| | on the mobile wireless communications |
| | device (note: location and context |
| | information from a previously recorded |
| | journey may still be stored on the aggregation |
| | server or the local device) |
| Menu→Play Journey | Presents the user with the list of past journeys |
| | and allows the user to select a journey to be |
| | ‘replayed’ on the device, showing the maps, |
| | locations, and multi-media content (images, |
| | voice recordings, text messages) associated |
| | with the locations |
| Menu→GPS→Granularity | Sets the distance necessary to travel or the |
| | time necessary to wait between triggering |
| | location displays on the map |
| Menu→Options→Send Position | Manually trigger capture of a current |
| | location, sending the captured location to the |
| | aggregation server |
| Menu→Capture Context | Triggers an context capture (e.g., an image |
| | capture using a camera attached to, |
| | communicating with, or integrated with the |
| | mobile wireless communications device), a |
| | location capture, and the subsequent |
| | transmission of the location and context |
| | information to the aggregation server |
| Menu→Images→View Sent | Displays images sent to the aggregation |
| | server by the user |
| Menu→Images→View Received | Displays images from the aggregation server |
| | that are sent by one or more other users |
| Menu->Images->View All | Displays images from the aggregation server |
| | that are sent by the user or received from the |
| | another user or other users |
| Menu→Zoom | Allows the user to zoom in or out of the map |
| | using a scroll control on the mobile wireless |
| | communications device |
| Menu→Destination→Select | Allows the user to select a destination with |
| | crosshairs shown on the map; the crosshairs |
| | are controlled by a scroll control on the |
| | mobile wireless communications device; the |
| | destination location is indicated by a |
| | differently colored location indicator on the |
| | map |
| Menu→Destination→Reset | Cancels the location indicator of the selected |
| | destination |
| Menu→Auto-Size→Show My Trail | In the tracking mode, adjusts the display to |
| | show only the user's trail |
| Menu→Auto-Size→Show Both (All) Trails | In the tracking mode, adjusts the display to |
| | show both the user's trail and the target's |
| | trail (i.e., another user's trail), or several |
| | trails if more than two users are involved) |
| Menu→Auto-Size→Show Target Trail | In the tracking mode, adjusts the display to |
| | show only the “target's trail” (i.e., another |
| | user's trail) |

In one implementation, a context capture event involves an image/video capture by a camera, which may be followed by a prompt to annotate the image with an audio recording and/or a text entry. Other combinations of context capture elements may be employed in other implementations. For example, a previously recorded audio message, music clip, video clip, images, etc. may be associated and communicated with the location information.

A “track” control 122 is provided in display 100 to provide access to tracking features of the aggregation client application. In one implementation, a tracking feature allows a user to associate with another user and track that other user's progress on the map. Context information can also be communicated between the two users, including without limitation text messages, images, audio message, and vocal telephone communications (e.g., so that the first user can provide directions to the second user—“Turn right when you get to Oak Street”).

In another implementation, one of the users can be represented by an object, such as a vehicle, a container, etc., or a non-human (e.g., a pet). The mobile wireless communications device can be attached or connected to the object and configured to periodically capture images, audio, etc., along with location information to provide a rich record of the object's travels.

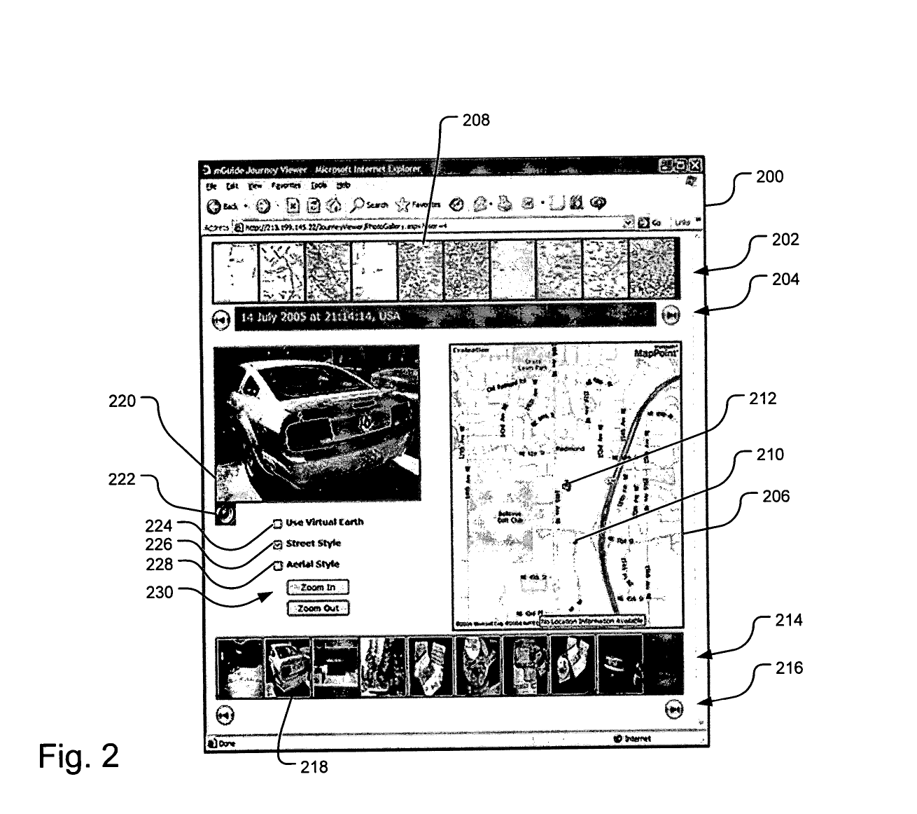

FIG. 2 illustrates an example display 200 of context information on a client device. An example client device may include a computer system having Internet access (whether by wired or wireless connection) and a web browser. The client device may be a mobile device or a stationary system, such as a desktop computer.

A map thumbnail panel 202, which is scrollable by controls 204, displays multiple thumbnails of map images. Each thumbnail map image represents a “journey”, a set of ostensibly related locations, although journeys can be defined arbitrarily by the user using a “New Journey” command to start a new set of locations. On mouse over, a tooltip appears with details about the journey, such as time, date, location, duration, number of images taken or received, etc. By selecting one of the thumbnail map images (see e.g., thumbnail map image 208), the user can navigate to the associated journey's context and location information. In an alternative implementation, each journey is designated by one or a collage of images taken during the journey. The designation may include text that indicates the location, time of day, date, and duration of the journey.

A map panel 206 shows a zoomed-in representation of a selected thumbnail map image 208. In one implementation, the map is retrieved from a web-based mapping service, such as Microsoft Corporation's VIRTUAL EARTH mapping service, through a web service at a web server to which the client is connected, although other sources of mapping data may be employed (e.g., other mapping services, CD or flash memory based maps, etc.). The map includes various locations indicators (see e.g., location indicator 210) and a camera indicator 212 (overlaid by a location indicator), which indicates that an image was captured at the indicated location. In one implementation, a camera indicator may also indicate that other context information was also or alternatively captured at the indicate location.

An image thumbnail panel 214, which is scrollable by controls 216, displays multiple thumbnail images associated with individual locations. By selecting one of the thumbnail images (see e.g., thumbnail image 218), the user can navigate to the associated location on the map in the map panel 206. In addition, the associated image 220 is displayed in a larger view, along with a speaker icon 222, which acts as a control for playing an associated audio message. Other controls, not shown, may be selected to view text information, video data, etc.

A control 224 selects whether to use Microsoft Corporation's VIRTUAL EARTH mapping service to provide the map. Another control 226 selects whether to identify roads on an aerial or satellite view of the map. The aerial or satellite view may be selected using a control 228, such that selecting both control 226 and 228 can provide an overlay of roads over the satellite view). “Zoom In” and “Zoom Out” controls 230 allow the user to zoom in and out on the map.

Using the user interface illustrated in FIG. 2, a user can access aspects of a mobile user's travels. As such, a daughter in Europe can view pictures from her mother's day on a business trip to the United States, hear her mother's voice describing the images she takes during the day, track her mother's movements relative to such images, etc.

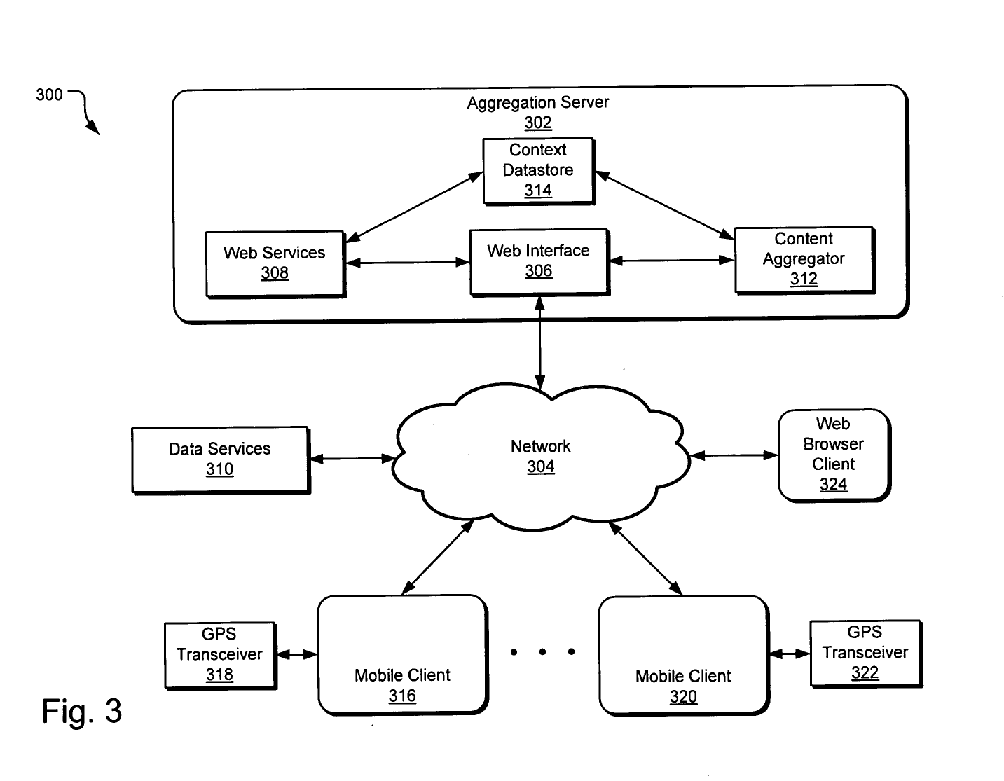

FIG. 3 illustrates an example system 300 that processes context information. An aggregation server 302 represents a web server that collects, stores, and serves context and location information to and from users via a network 304. It should be understood that the network 304 may be a collection of different networks, which may support a variety of networking protocols, channels, and devices.

Mobile and non-mobile clients can access the aggregation server 302 via a web interface 306, which typically supports HyperText Transport Protocol (HTTP), Simple Object Access Protocol (SOAP), and/or Extensible Markup Language (XML). Mobile clients can access a web services module 308 via the web interface 306. Web services are software applications identified by a URL, whose interfaces and bindings are capable of being defined, described, and discovered, such as by XML artifacts. A web service supports direct interactions with other software agents using (e.g., XML-based) messages exchanged over the network 304 (e.g., the Internet) and used remotely. A web service is accessible through a standard interface, thereby allowing heterogeneous systems to work together as a single web of computation. Web services use these standardized protocols (e.g., HTTP, SOAP, XML, etc.) to exchange data between systems that might otherwise be completely incompatible. It should be understood, however, that mapping information can be obtained from a variety of mapping resources, including mapping web services, a mapping datastore, or a mapping application.

In addition, the aggregation server 302 can communicate with other data services 310 (such as a web service for obtaining mapping data, web search services, weather forecasting services, etc.) via a content aggregator 312 and the web interface 306, again via standardized protocols such as HTTP, SOAP, XML, etc. The content aggregator 312 uses appropriate communication protocols to obtain information from Web services or other data resources. The content aggregator 312 merges this information with the user's personal information and thus facilitates the provision and display of the aggregated information.

A mobile client 316, for example, captures location information from the GPS transceiver 318, captures context information (e.g., from an integrated camera), and accesses the web services module 308 via the web interface 306 to record the context information and location information in a context datastore 314. In one implementation, the datastore 314 is in the form of an SQL database, although other datastore forms are contemplated including other relational databases, file systems and other data organizations. In one implementation, the web services module 308 accesses the datastore 314 via a data access component, such as ADO.NET. FIG. 1 illustrates an example user interface of a mobile wireless communication device. In another implementation, the aggregation server process may reside on the mobile device and the communication and aggregation of information can be facilitated by a peer-to-peer communications among the devices.

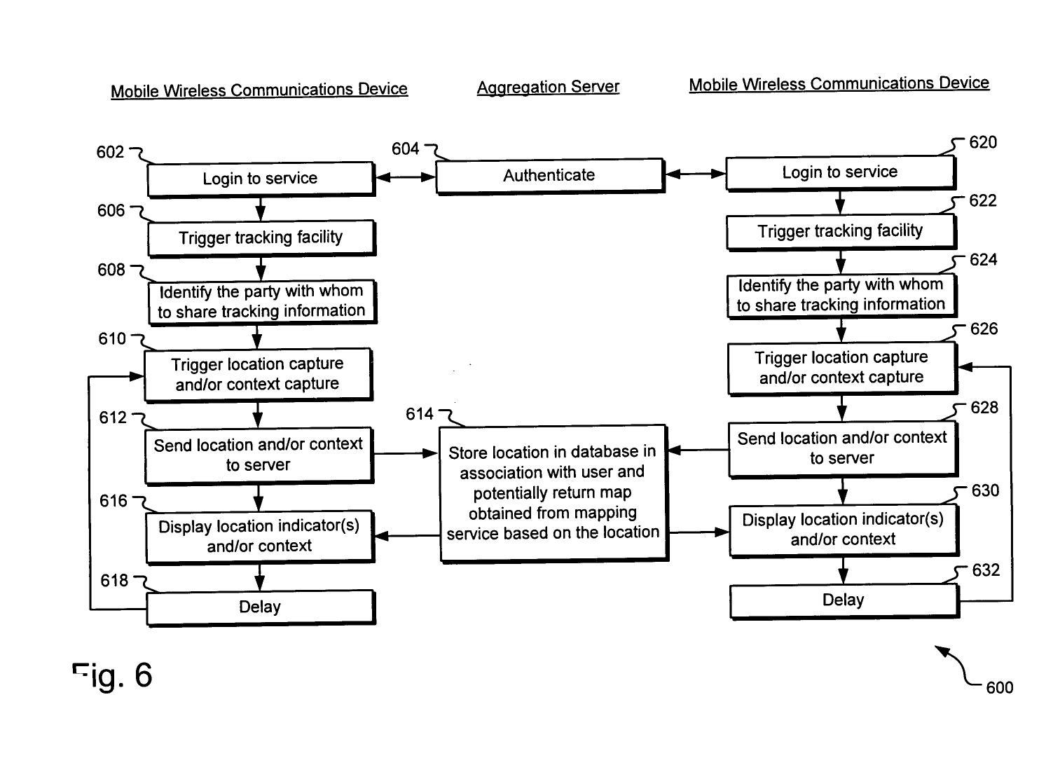

It should also be understood that another mobile client 320 can also access the datastore 314 via the network 304 and web services 308, providing its own context information (e.g., captured by an integrated camera or audio recorder) and location information (e.g., captured by a communicatively coupled GPS transceiver 322. The multiple mobile clients 316 and 320 can access the datastore 314 via web services 308 and share their context information and location information, thereby allowing each user to track the travels and context of the other user. See e.g., the description of FIG. 6.

A web browser client 324 can also access the datastore 314 via the web interface 306 and web services 308 to view the context and location information of another user. The user's information can be identified via a simple Uniform Resource Identifier (URI) or protected through an authentication layer, which limits access to the information. FIG. 2 illustrates an example user interface of a web browser client.

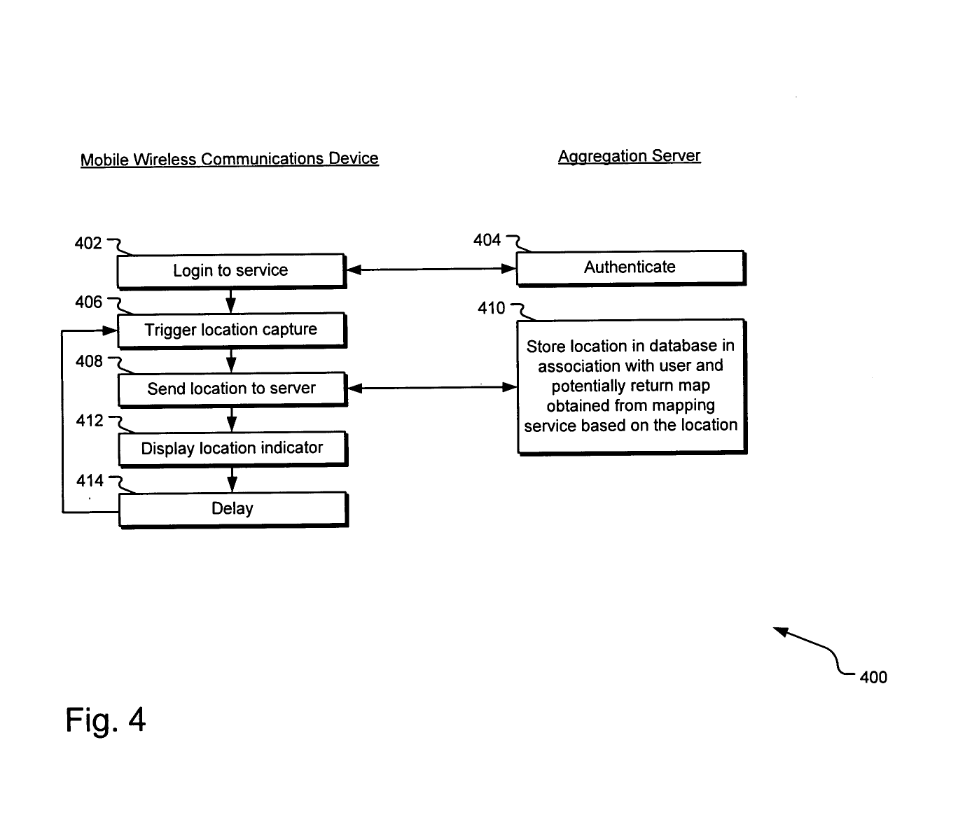

FIG. 4 illustrates example operations 400 for processing location information on a mobile wireless communications device. A login operation 402 logs a user into an aggregation server via the user's mobile wireless communications device. In an authentication operation 404, the aggregation server authenticates the user and then allows access to the user's data in a context datastore. It should be understood that some implementations need not authenticate the user.

A trigger operation 406 triggers a location capture. The GPS transceiver may provide a continuous stream of location data to the mobile device. Nevertheless, an example trigger operation 406 can cause the mobile device and the resident application to capture the location information for use in the system. In one implementation, the triggering is based on periodic capture interval, such as distance traveled interval or a time interval. The trigger operation 406 contacts a GPS or other positioning transceiver to obtain a location tag. In one implementation, a location tag includes location information (e.g., longitude and latitude values) and a timestamp, although other formats of location tag are also contemplated. A transmission operation 408 sends the location information to the aggregation server, which stores the location information in the datastore in association with the user's other stored information in a server operation 410. The aggregation server can also obtain from a mapping data service a map associated with the location specified in the location tag and return this map to the mobile wireless communications device.

A display operation 412 displays a location identifier in the map, wherein the location identifier indicates the captured location from the location tag. The display operation 412 is shown as being performed by the mobile wireless communications device, but it should be understood that the aggregation server can render the location indicator into the map before transmitting the map to the mobile wireless communications device, a desktop device, or any other computing environment accessing the data through the web service. A delay operation 414 delays a subsequent trigger operation 406 for an appropriate interval, although a manually trigger capture event could intervene (e.g., a trigger event caused by an image capture, an audio capture, a manual trigger, etc.).

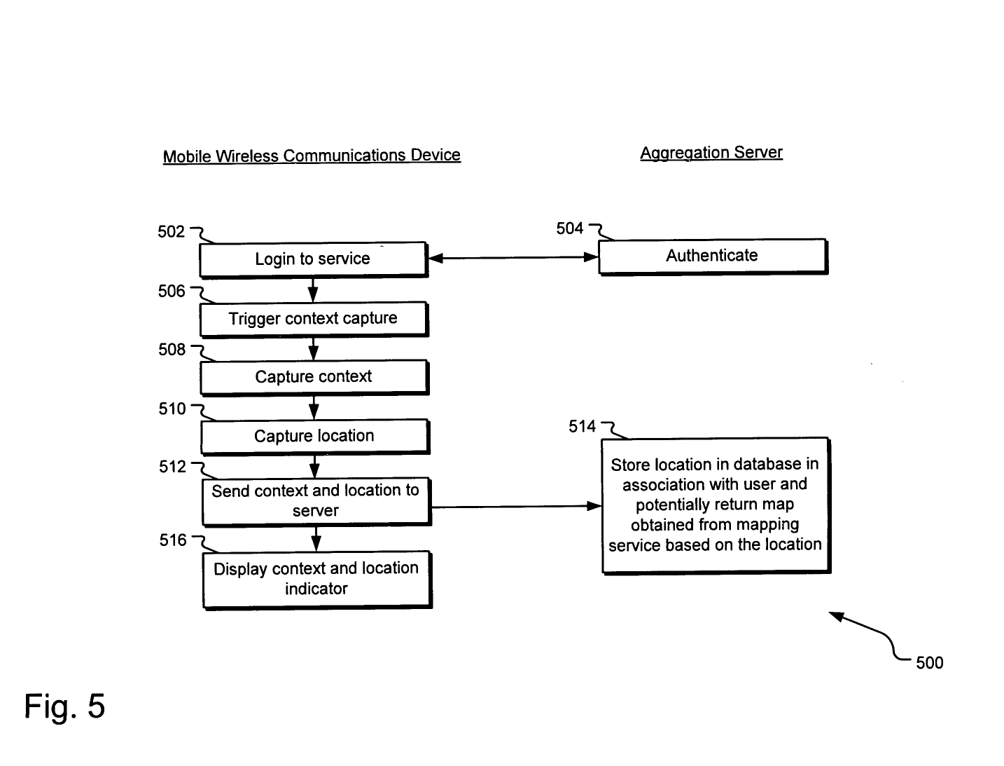

FIG. 5 illustrates example operations 500 for processing context information on a mobile wireless communications device. A login operation 502 logs a user into an aggregation server via the user's mobile wireless communications device. In an authentication operation 504, the aggregation server authenticates the user and then allows access to the user's data in a context datastore. It should be understood that some implementations need not authenticate the user.

A trigger operation 506 triggers a context capture. In one implementation, the triggering is based on a user selecting a camera control, an audio recording control, a text message control, etc. A capture operation 508 executes the appropriate capture facility in the phone, such as a camera, audio recorder, etc. Then, responsive to the capture operation 508, another capture operation 510 contacts a GPS or other positioning transceiver to obtain a location tag. It should be understood that the process of FIG. 5 can allow integrated capture of multiple information types (e.g., location information, images, video, audio, etc.) in a single application and through a single user interface.

A transmission operation 512 sends the captured context information (e.g., an image file) and captured location information to the aggregation server, which stores the information in the datastore in association with the user's other stored information in a server operation 514. The aggregation server can also obtain from a mapping data service a map associated with the location specified in the location tag and return this map to the mobile wireless communications client.

A display operation 516 displays the context information and a location identifier in the map, wherein the location identifier indicates the captured location from the location tag. The display operation 516 is shown as being performed by the mobile wireless communications device, but it should be understood that the aggregation server can render the location indicator and context information into the map before transmitting the map to the mobile wireless communications device. It should be understood that the process of FIG. 5 can allow integrated presentation of multiple information types (e.g., location information, images, video, audio, etc.) in a single application and through a single user interface.

FIG. 6 illustrates example operations 600 for tracking context information on two mobile wireless communications devices. Login operations 602 and 620 log the users into an aggregation server via the users' mobile wireless communications devices. In an authentication operation 604, the aggregation server authenticates the users and then allows each user to access to the users' individual data in a context datastore. It should be understood that some implementations need not authenticate either user.

Trigger operation 606 and 622 initiate a tracking facility in each of the mobile wireless communications devices. Within the respective tracking facilities, identification operations 608 allow each user to grant the other user with access to their individual data in the context datastore, thereby allowing the other user to see their current journey. In one implementation, this grant is accomplished by selecting another user's contact information from a user list (e.g., a user from a contact list in a contact management application on the mobile wireless communications device).

Trigger operations 610 and 626 trigger location and/or context captures. For example, the trigger operation 610 can be set up to capture location information on an interval basis. The trigger operation 610 may nevertheless trigger a context capture event to obtain images, audio, text, etc. In one implementation, the triggering is based on a user selecting a camera control, an audio recording control, a text message control, etc. When executed, capture operations (such as operation 508 and 510 of FIG. 5) are included in the trigger operations 610 and 626. It should be understood that the process of FIG. 6 can allow integrated capture of multiple information types (e.g., location information, images, video, audio, etc.) in a single application and through a single user interface.

Transmission operations 612 and 628 send the captured context information (e.g., an image file) and/or captured location information to the aggregation server, which stores the information in the datastore in association with the user's other stored information in a server operation 614. The aggregation server can also obtain from a mapping data service a map associated with the location specified in the location tag and return this map to the mobile wireless communications clients. It should be understood that the individual users may be positioned at sufficiently different locations that the maps sent to each mobile wireless communications client represents different geographical areas. It should also be understood that aggregation can be accomplished by coordinating communications among aggregator services that may reside on individual user's devices equipped by web services or other services enabling exchange of data among devices.

Display operations 616 and 630 display the context information and location identifiers in the maps, wherein the location identifiers indicate the captured location from the location tag of one or both of the mobile wireless communications devices. It should be understood that the process of FIG. 6 can allow integrated display of multiple information types (e.g., location information, images, video, audio, etc.) in a single application and through a single user interface. The render operations 616 and 630 are shown as being performed by the mobile wireless communications devices, but it should be understood that the aggregation server can render the location indicators and context information into the maps before transmitting them to the mobile wireless communications devices. A delay operation 614 delays a subsequent trigger operation 606 for an appropriate interval, although a manually trigger capture event could intervene (e.g., a trigger event caused by an image capture, an audio capture, etc.).

Using the example tracking facility described with regard to FIG. 6, a first user can view the travel path of second user and receive context information captured by the second user along the travel path. Likewise, the first user can view his or her own travel path as well as context information he or she captures along the way. Also, either user can send messages to the other user concurrently with the location and context capture events (e.g., to provide assistance in finding a desired location, etc.).

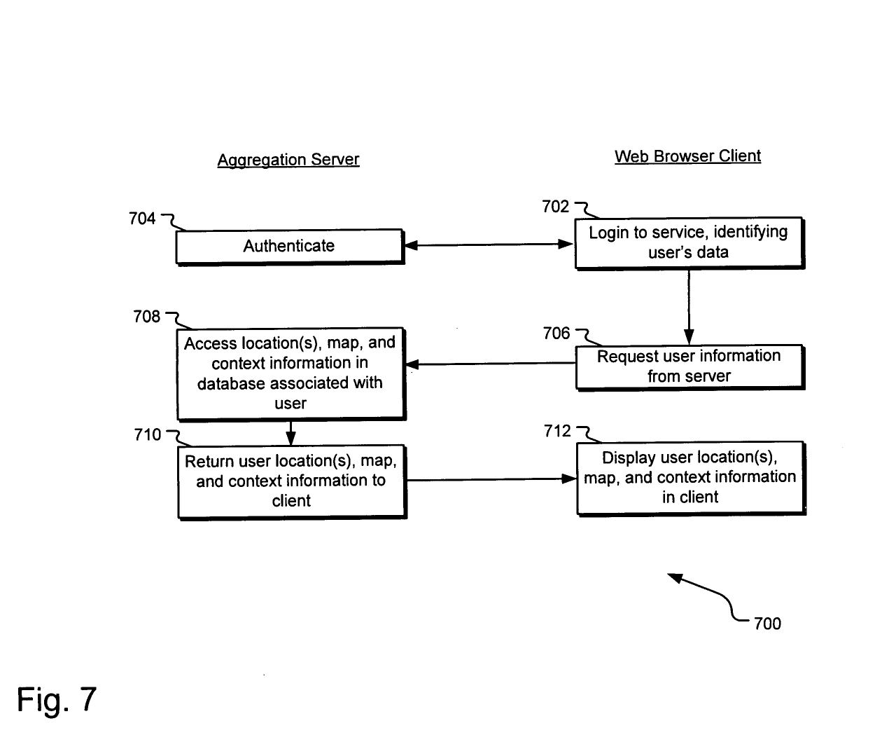

FIG. 7 illustrates example operations 700 for accessing context information captured by a mobile wireless communications device. A login operation 702 logs a first user into an aggregation server via the user's web browser client. In this operation, the first user identifies a second user whose information he or she wishes to access. In an authentication operation 704, the aggregation server authenticates the first user and then allows access to the second user's data in a context datastore. It should be understood that some implementations need not authenticate either user and that the context datastore for individual users can reside on their respective client devices, equipped by web services or other services enabling exchange of data among devices.

A request operation 706 requests the aggregation server for the second user's information. The aggregation server access the context datastore for the location information, associated mapping information, and context information associated with the second user in access operation 708. A returning operation 710 returns the user information to the web browsing client as a rendered web page, which is displayed by the web browsing client in display operation 712. Through the web page, the first user can view the map, the location indicators, the camera indicators, etc., hear the audio recordings, view the text messages, and generally experience the second user's travels, including context information captured by the second user during these travels. It should be understood that the process of FIG. 7 can allow integrated display of multiple information types (e.g., location information, images, video, audio, etc.) in a single application and through a single user interface.

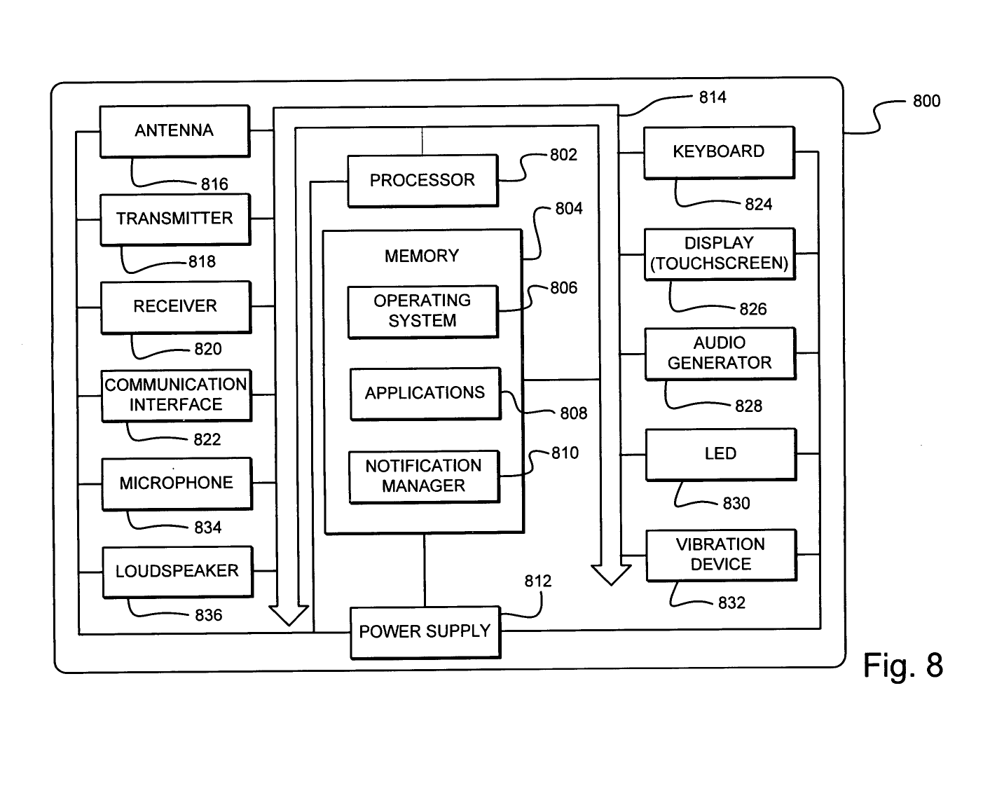

An example mobile device 800 can be useful as a mobile wireless communications device is depicted in FIG. 8. It should be understood that other mobile device configurations are also contemplated. The mobile device 800 includes a processor 802 and memory 804 as in any standard computing device. The processor 802, memory 804, and other components hereinafter described may interface via a system bus 814. The system bus 814 may be any of several types of bus structures including a memory bus or memory controller, a peripheral bus, a switched fabric, point-to-point connections, and a local bus. The memory 804 generally includes both volatile memory (e.g., RAM) and non-volatile memory (e.g., ROM or a PCMCIA card). An operating system 806 may reside in the memory 804 and execute on the processor 802. An example operating system may be the WINDOWS® CE operating system from Microsoft Corporation.

One or more application programs 806 may be loaded into the memory 804 for execution by the processor 802 in conjunction with the operating system 806. Example applications may include aggregation client programs, electronic mail programs, scheduling programs, personal information management programs, word processing programs, spreadsheet programs, Internet browser programs, music file management programs, and photograph and video file management programs. The memory 804 may further include a notification manager 810, which executes on the processor 802. The notification manager 810 handles notification requests from the applications 808 to one or more user notification devices as described in greater detail below.

The mobile device 800 also has a power supply 812, which may be implemented using one or more batteries. The power supply 812 may also be from an external AC source through the use of a power cord or a powered data transfer cable connected with the mobile device 800 that overrides or recharges the batteries. The power supply 812 is connected to most, if not all, of the components of the mobile device 800 in order for each of the components to operate.

In one implementation, the mobile device 800 may include communications capabilities, for example, the mobile device 800 operates as a wireless telephone. A wireless device 800 with telephone capabilities generally includes an antenna 816, a transmitter 818, and a receiver 820 for interfacing with a wireless telephony network. Additionally, the mobile device 800 may include a microphone 834 and loudspeaker 836 in order for a user to telephonically communicate. The loudspeaker 836 may also be in the form of a wired or wireless output port for connection with a wired or wireless earphone or headphone.

The mobile device 800 may connect with numerous other networks, for example, a wireless LAN (WiFi) network, a wired LAN or WAN, GPRS, Bluetooth, UMTS or any other network via one or more communication interfaces 822. The antenna 816 or multiple antennae may be used for different communication purposes, for example, radio frequency identification (RFID), microwave transmissions and receptions, WiFi transmissions and receptions, and Bluetooth transmissions and receptions.

The mobile device 800 further generally includes some type of user interface. As shown in FIG. 8, the mobile device 800 may have a keyboard 824 and a display 826. The keyboard 824 may be a limited numeric pad, a full “qwerty” keyboard, or a combination of both. The keyboard 824 may also include specialty buttons, wheels, track balls, and other interface options, for example, menu selection or navigation keys or telephone function keys. In addition to depicting information, the display 826 may also be a touch screen display that allows for data entry by touching the display screen with the user's finger or a stylus to make input selections via a graphical interface or write letters and numbers directly on the display 826.

The mobile device 800 may also have one or more external notification mechanisms. In the implementation depicted in FIG. 8, the mobile device 800 includes an audio generator 828, a light emitting diode (LED) 830, and a vibration device 832. These devices may be directly coupled to the power supply 812 so that when activated, they may remain energized for a duration dictated by the notification manager 810, even though the processor 802 and other components may shut down to conserve battery power.

In an example implementation, an aggregation client and other modules may be embodied by instructions stored in memory 804 and processed by the processing unit 802. Location tags, context information, (including images, video, audio, text, etc.), and other data may be stored in memory 804 as persistent datastores.

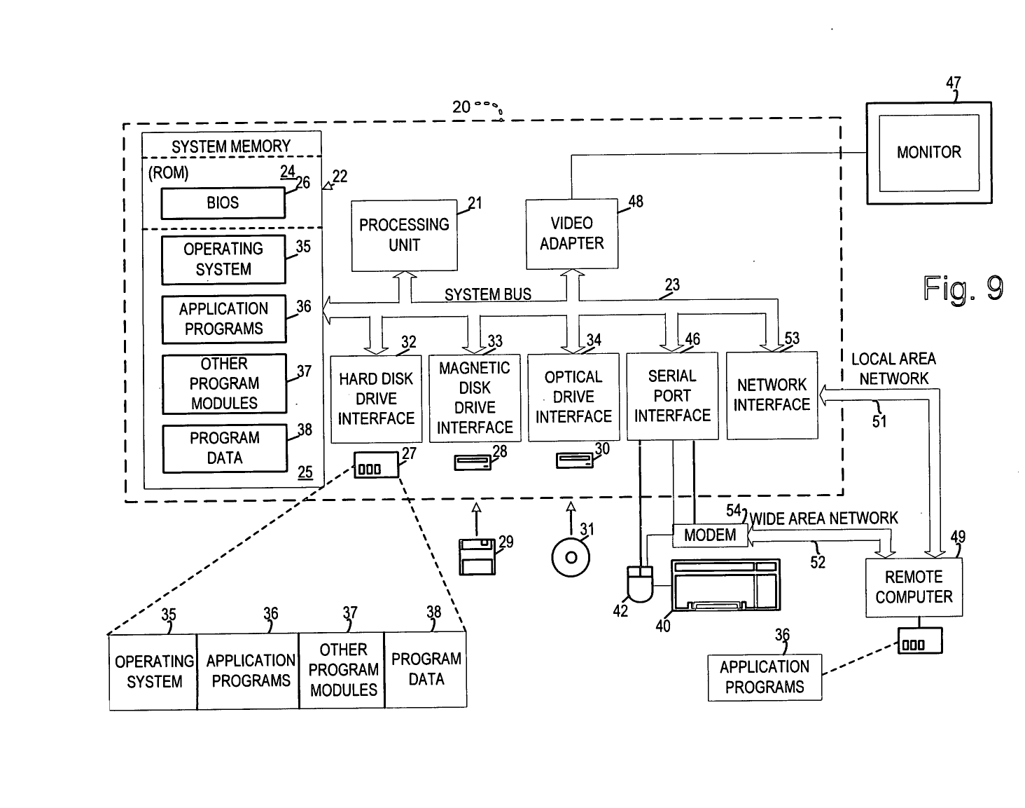

The example hardware and operating environment of FIG. 9 for implementing the invention includes a general purpose computing device in the form of a gaming console or computer 20, including a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 9. The logical connections depicted in FIG. 9 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are example and other means of and communications devices for establishing a communications link between the computers may be used.

In an example implementation, a web service module, a web interface module, a content aggregator module and other modules may be embodied by instructions stored in memory 22 and/or storage devices 29 or 31 and processed by the processing unit 21. Location tags, location information, and context information, including images, video, audio, text, etc., and other data may be stored in memory 22 and/or storage devices 29 or 31 as persistent datastores.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the implementations of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example implementations of the invention. Although various implementations of the invention have been described above with a certain degree of particularity, or with reference to one or more individual implementations, those skilled in the art could make numerous alterations to the disclosed implementations without departing from the spirit or scope of this invention. In particular, it should be understood that the described technology may be employed independent of a personal computer. Other implementations are therefore contemplated. It is intended that all matter contained in the above description and shown in the accompanying drawings shall be interpreted as illustrative only of particular implementations and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method of processing context information relating to location information, the method comprising:
capturing the context information using a mobile wireless communications device;
triggering capture of the location information by the mobile wireless communications device, in response to the capturing of the context information;
transmitting the captured context information in association with the captured location information from the mobile wireless communications device to a mapping resource at a web server for aggregation with mapping data.

2. The method of claim 1 further comprising:
receiving a map from the mapping resource, wherein the map relates to a location identified by the location information;
displaying the map on the mobile wireless communications device;
displaying a location indicator at the location in the map on the mobile wireless communications device.

3. The method of claim 1 further comprising:
receiving a map from the mapping resource, wherein the map relates to a location identified by the location information;
displaying the map on the mobile wireless communications device;
displaying a location indicator at the location in the map on the mobile wireless communications device;
presenting the captured context information concurrently with the map via the mobile wireless communications device.

4. The method of claim 1 wherein the context information includes a digital image captured by the mobile wireless communications device.

5. The method of claim 1 wherein the context information includes a digital audio recording captured by the mobile wireless communications device.

6. The method of claim 1 wherein the context information includes a text message captured by the mobile wireless communications device.

7. The method of claim 1 further comprising:
receiving a map from the mapping resource, wherein the map relates to a location identified by the location information and another location identified by other location information captured by another mobile wireless communications device;
receiving context information captured by the other mobile wireless communications device;
displaying the map on the mobile wireless communications device;
displaying a location indicator at the other location in the map on the mobile wireless communications device;
presenting the context information captured by the other mobile wireless communications device concurrently with the map via the mobile wireless communications device.

8. The method of claim 1 further comprising:
receiving a map from the mapping resource, wherein the map relates to a location identified by the location information and another location identified by other location information captured by another mobile wireless communications device;
receiving context information captured by the other mobile wireless communications device;
displaying the map on the mobile wireless communications device;
displaying a location indicator at the other location in the map on the mobile wireless communications device;
presenting the context information captured by the other mobile wireless communications device concurrently with the map via the mobile wireless communications device;
updating display of the map on the mobile wireless communications device with an additional location indicator that indicates a location representing location information captured by the other mobile wireless communications device following the operation of displaying the location indicator.

9. A computer-readable medium having computer-executable instructions for performing a computer process that implements the operations recited in claim 1.

10. A method of processing context information relating to location information, the method comprising:
receiving captured context information and associated captured location information from a mobile wireless communications device;
obtaining a map including a location specified by the location information, the map being obtained from a mapping resource;
transmitting the map and the captured context information to a client;

11. The method of claim 10 wherein the client includes the mobile wireless communications device, such that the map is returned to the mobile wireless communications device.

12. The method of claim 10 wherein the client includes a computing device that is different from the mobile wireless communications device that captured the context information and the associated captured location information and the location specified by the location information is indicated on the map.

13. The method of claim 10 wherein the context information includes a digital image captured by the mobile wireless communications device.

14. The method of claim 10 wherein the context information includes a digital audio recording captured by the mobile wireless communications device.

15. The method of claim 10 wherein the context information includes a text message captured by the mobile wireless communications device.

16. A computer-readable medium having computer-executable instructions for performing a computer process that implements the operations recited in claim 10.

17. A method of processing context information relating to location information, the method comprising:
receiving context information and an associated map indicating a location based on location information, the context information and the location information being captured by a mobile wireless communications device and the map being obtained from a mapping resource;
presenting the captured context information and the associated map concurrently on a client device.

18. The method of claim 17 wherein the context information includes a digital image captured by the mobile wireless communications device and the presenting operation displays the image concurrently with the associated map on the client device.

19. The method of claim 17 wherein the context information includes a digital audio recording captured by the mobile wireless communications device and the presenting operation audibly plays the digital audio recording concurrently with display of the associated map via the client device.

20. A computer-readable medium having computer-executable instructions for performing a computer process that implements the operations recited in claim 17.
